(19) United States
(12) Patent Application Publication
(10) Pub. No.: US 2018/0073419 A1
(43) Pub. Date: Mar. 15, 2018

(54) THERMOSTAT ASSEMBLY WITH CONTROLLED FLUID INTAKE

(71) Applicant: M.A.P MOTORAD AUTOMOTIVE PARTS LTD., Misgav (IL)

(72) Inventor: Aviram ARBEL, Hod Hasharon (IL)

(21) Appl. No.: 15/561,060

(22) PCT Filed: Mar. 24, 2016
(86) PCT No.: PCT/IL2016/050316

§ 371 Date: Sep. 24, 2017

Related U.S. Application Data
(60) Provisional application No. 62/137,832, filed on Mar. 25, 2015.

(51) Int. Cl. F01P 7/16; F01P 7/14; G05D 23/13

(52) U.S. Cl. CPC F01P 7/16; F01P 7/14; F01P 2025/46; F01P 2007/146; G05D 23/1333

(57) ABSTRACT

A thermostat with a temperature sensitive valve and a sample orifice for delivering sample fluids from a predetermined site, such that the actuation of the temperature sensitive valve is conducted based on the temperature of the sample fluids.

### FIELD OF THE INVENTION

The present disclosure generally relates to the field of thermostats and temperature based fluid flow control.

BACKGROUND

Thermostatic valves are regularly used for controlling the flow of fluids based on sensed temperature. In combustion engines, for example, thermostats are utilized for regulating the temperature of the engine by controlling the flow of coolant fluid from the radiator to the engine. When the sensed temperature exceeds a certain value, the valve opens by distancing a valve plug from a valve seat, allowing flow of low temperature fluid from the radiator to the engine, thereby lowering the engine temperature to prevent overheating. Alternatively, when the sensed temperature is below a certain level, the valve closes by introducing the valve plug to the valve seat, obstructing the flow of low temperature fluid from the radiator to the engine, thereby allowing the temperature of the engine to rise and reach a desired temperature range.

The sensing of the temperature, and the control over the flow of fluids accordingly, is done using a heat sensitive material by introducing coolant fluids thereto. The fluids that are introduced to the heat-sensitive material are not homogeneously mixed and can include high temperature fluids from the engine and low temperature fluids from the radiator. Therefore, the sensed temperature is not indicative of the real temperatures of the engine or of the fluids going to the engine. As a result, a non-optimal valve behavior is expected, leading to increased levels of pollutants and inefficiency both in fuel consumption and in power delivery of the engine.

There is thus a need in the art for thermostat systems that provide valve control based on homogeneous mixtures of fluids.

### SUMMARY OF THE INVENTION

The following embodiments and aspects thereof are described and illustrated in conjunction with systems, kits and devices which are meant to be exemplary and illustrative, not limiting in scope. In various embodiments, one or more of the above-described problems have been reduced or eliminated, while other embodiments are directed to other advantages or improvements.

According to some embodiments, the present disclosure is directed to thermostat systems having a sample fluid intake for delivering homogeneously mixed sample fluids to the heat-sensitive valve in the thermostat.

According to some embodiments, sample fluids may be delivered to the thermostat from a specific area of interest, at which the temperature is indicative of the temperature of the engine. Advantageously, providing the heat-sensitive valve with samples having accurate temperatures indicative of the temperature of the engine may result in a more desirable behavior of the valve.

Advantageously, providing the heat-sensitive material a homogeneous mixture of sample fluids may result in an accurate behavior of the thermostat valve depending on the temperature of a known specific area and not being vulnerable to temperature changes due to the exposure to mal-mixed high temperature and low temperature fluids. A behavior of the valve that follows the temperature of the engine in a more accurate manner may result in better energy-efficiency, lower exhaust pollutants and an improved power delivery from the engine.

According to some embodiments, there is provided herein a thermostat for controlling flow of a coolant fluid through an aperture, the thermostat including a temperature sensitive valve for controlling an opening and closing of the aperture, the temperature sensitive valve including a valve body including a heat sensitive material and a displaceable pin, wherein the displaceable pin is at least partially inserted within the heat sensitive material, and a coolant input orifice configured to convey coolant fluid from a radiator to the valve. The thermostat further includes a main input orifice configured to convey fluid from an engine to the valve, an output orifice configured to release fluid from the valve, and a sample orifice configured to deliver a sample fluid to the valve body such that a temperature of the heat sensitive material is affected by temperature changes in the sample fluid.

According to some embodiments, the thermostat further includes a sleeve at least partially surrounding the valve body, the sleeve is configured to receive the sample fluid and introduce it to the valve.

According to some embodiments, the sleeve is a tubular structure.

According to some embodiments, the sample orifice has a cross-section surface of at least 1 mm2.

According to some embodiments, the sample orifice is configured to deliver sample fluid from a pump to the valve body.

According to some embodiments, the sample orifice is configured to deliver sample fluid from an engine to the valve body.

According to some embodiments, the sample orifice is configured to deliver sample fluid from the output orifice to the valve body.

According to some embodiments, the temperature sensitive valve further includes an upper lid, connected to or integrally formed with a flange and configured to reversibly seal the aperture.

According to some embodiments, there is provided herein a method for controlling flow of a coolant fluid through an aperture, the method including providing a temperature sensitive valve including a heat sensitive material and a displaceable pin and an upper lid, integrally formed with a flange and configured to reversibly seal the aperture by the displacement of the pin, introducing sample fluids to the temperature sensitive valve through a sample orifice, and controlling an opening and closing of the aperture based on temperatures of the sample fluids introduced to the heat sensitive valve.

According to some embodiments, there is provided a method wherein the temperature sensitive valve further includes a sleeve configured to receive the sample fluids from the sample orifice and introduce them to the valve.

According to some embodiments, the sleeve is a tubular structure.

According to some embodiments, the sample orifice is configured to deliver sample fluid from a pump to the valve body.

According to some embodiments, the sample orifice is configured to deliver sample fluid from an engine to the valve body.

According to some embodiments, the temperature sensitive valve further includes an output orifice and the sample orifice is configured to deliver sample fluid from the output orifice to the valve body.

Certain embodiments of the present disclosure may include some, all, or none of the above advantages. One or more technical advantages may be readily apparent to those skilled in the art from the figures, descriptions and claims included herein. Moreover, while specific advantages have been enumerated above, various embodiments may include all, some or none of the enumerated advantages.

In addition to the exemplary aspects and embodiments described above, further aspects and embodiments will become apparent by reference to the figures and by study of the following detailed descriptions.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1 schematically illustrates a thermostat assembly with an engine, according to some embodiments;

FIG. 2 schematically illustrates a thermostat with a sample fluid orifice, according to some embodiments; and

FIGS. 3A-C illustrate fluid flow diagrams of a thermostat with other components, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, the present disclosure provides thermostat assemblies and valves that bring advantageous features for accurate temperature sensing of fluids in thermostats with heat-sensitive valves.

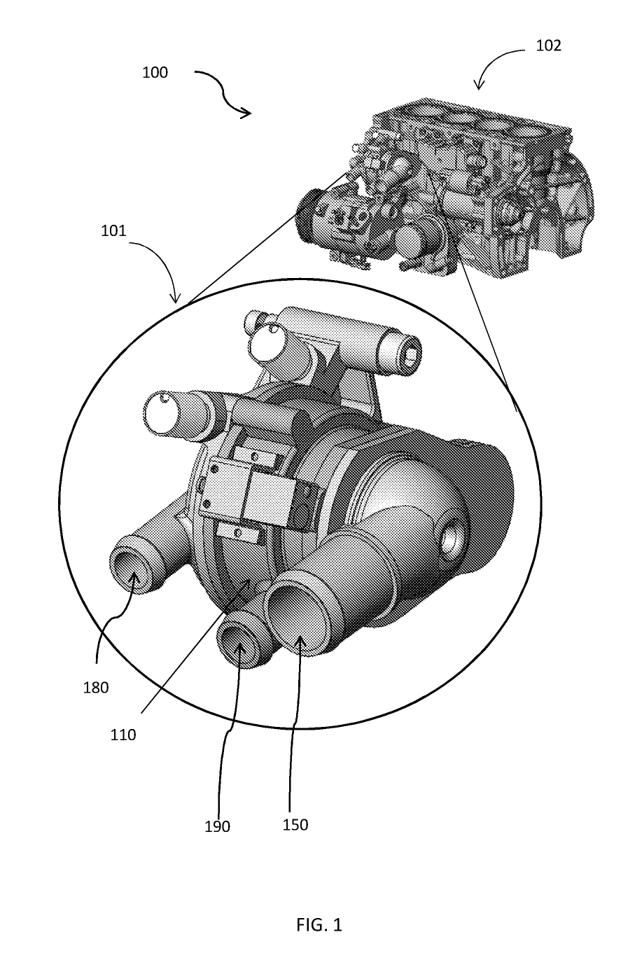

Reference is now made to FIG. 1 which schematically illustrates an assembly 100 of a thermostat 101 and an engine 102, according to some embodiments.

In general, thermostat 101 is configured to regulate the temperature of engine 102 and, optionally, other components of interest by controlling the flow of coolant fluid using a heat-sensitive valve 110 within thermostat 101.

Thermostat 101 has a plurality of orifices/passages for delivering fluids to/from thermostat 101. Fluid intake of the radiator is conducted via a radiator orifice 150 configured to deliver low temperature fluids from a radiator, an engine orifice 180 configured to deliver fluids from engine 102 and, optionally, a reservoir or heater orifice 190 configured to deliver fluids from an optional fluid reservoir or heater to thermostat 101.

Heat-sensitive valve 110 determines whether to block or allow the flow of fluid from radiator orifice 150 through the thermostat to an output orifice (not shown). When the temperature sensed by heat-sensitive valve 110 exceeds a predetermined value, heat-sensitive valve 110 opens, allowing for coolant fluids to flow from radiator orifice 150 to output orifice (not shown), thereby introducing low temperature fluids to engine 102 and lowering the temperature thereof. When the temperature of heat-sensitive valve 110 drops below a predetermined value, heat-sensitive valve 110 closes, obstructing the flow of coolant fluids from radiator orifice 150 to output orifice (not shown) and allowing flow of fluids from engine orifice 180 and optionally reservoir (not shown) or heater orifice 190 to output orifice (not shown), thereby circulating high-temperature fluids to engine 102, allowing it to reach higher temperatures.

Heat-sensitive valve 110 senses the temperature of a non-homogeneous mixture of fluid with varying temperatures. The fluid mixture is a combination of fluids entering from engine orifice 180, fluids from heater orifice 190, and fluids from radiator orifice 150. Because the fluid mixture is not homogeneously mixed, heat-sensitive valve 110 is exposed to various temperatures that do not provide accurate indication of the desired temperature (for example, the temperature of fluids entering the engine).

Embodiments of the disclosure suggest introducing the heat-sensitive valve 110 with a sample fluid that comprises a homogeneous mixture of fluids that better represents and thus indicates the temperature of a desired area (for example, engine temperature).

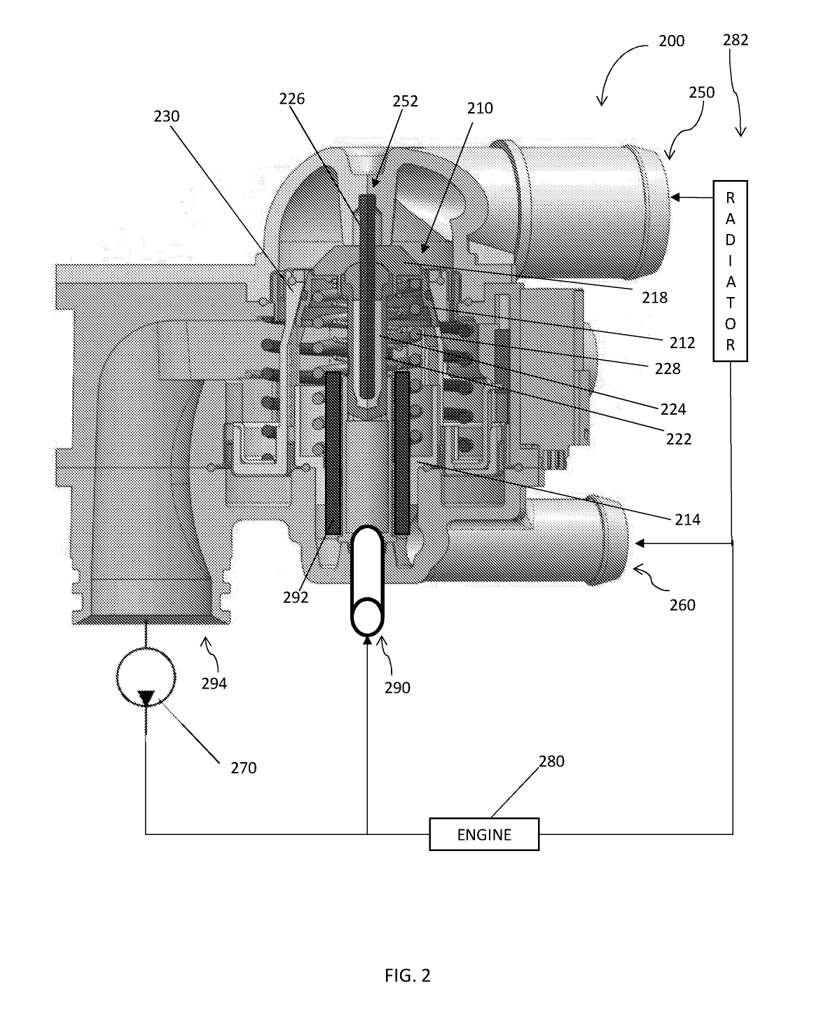

Reference is now made to FIG. 2, which schematically illustrates a thermostat 200 with a sample fluid orifice 290, according to some embodiments. Thermostat 200 includes a heat-sensitive valve 210 which comprises an upper lid 218 mechanically connected to (or integrally formed with) a flange 212 and a valve body 222 containing a heat-sensitive material 224. A pin 226 is at least partially immersed in heat sensitive material 224 and passes through upper lid 218.

When heated above a predetermined temperature, heat-sensitive material 224 is configured to expand, and push against pin 226, extending it from the original position thereof. When cooled below a predetermined temperature, heat sensitive material 224 contracts, allowing for pin 226 to retract to the original position thereof.

Heat-sensitive valve 210 is placed within thermostat 200 such that pin 226 is partially engaged within a niche 252 and upper-lid 218 with flange 212 is adjacent to valve seat 230. A spring 228 pushes against upper lid 218 and forces it against valve seat 230. A lower element 214 provides support to spring 228.

A radiator orifice 250 is configured to deliver fluids from a radiator 282 to thermostat 200, and engine orifice 260 is configured to deliver fluids from an engine 280 to thermostat 200. A sample orifice 290 in thermostat 200 is configured to deliver mixed sample fluids from a pump 270 to thermostat 200, and sleeve 292 is configured to introduce the sample fluids from sample orifice 290 to valve body 222. An output orifice 294 is configured to deliver fluids from thermostat 200 to pump 270.

When the temperature of heat-sensitive material 224 is low, pin 226 is withdrawn within valve body 222, and spring 228 pushes against upper-lid 218 with flange 212 to fasten them to valve seat 230, thereby inducing valve 210 to assume a closed position.

In such closed position, flow of fluids from radiator orifice 250 to output orifice 294 is obstructed, and flow of fluids from engine orifice 260 and sample orifice 290 through output orifice 294 is allowed. While in the closed position, engine 280 may operate and increase the temperature thereof, resulting in increasing the temperature of fluids through engine orifice 260 and also increasing the temperature of the sample fluids delivered by sample orifice 290.

As the temperature of the sample fluids rises, the sensed temperature by valve body 222 rises as it is washed by the sample fluids through sleeve 292. When the temperature of sample fluids reaches or exceeds a predetermined temperature value (start-to-open temperature, STO), the temperature of heat-sensitive material 224 rises accordingly, causing it to expand and push pin 226 outwards against niche 252. Niche 252 is fixed and unmovable and therefor the force generated from extending pin 226 pushes the rest of heat-sensitive valve 210 components downwards, parting upper-lid 218 and flange 212 from valve seat 230, forcing heat-sensitive valve 210 to assume an open position (not shown), thereby allowing for fluids to pass from radiator orifice 250 towards output orifice 294.

In the open position, fluid from radiator orifice 250 and engine orifice 260 flow through thermostat 200, resulting in a flow of a mixture of low temperature radiator fluid and high temperature engine fluid through output orifice 294. This mixture then passes through pump 270 to get further mixed and is then delivered to engine 280 to lower the engine temperature. A small sample portion of the fluids is also delivered to sample orifice 290 and introduced to valve body 222.

The result is that valve body 222 is constantly introduced with fluids having the same temperature as the fluids being introduced to engine 280, without being exposed to low temperature fluids from radiator orifice 250 that do not represent/follow the temperature of engine 280.

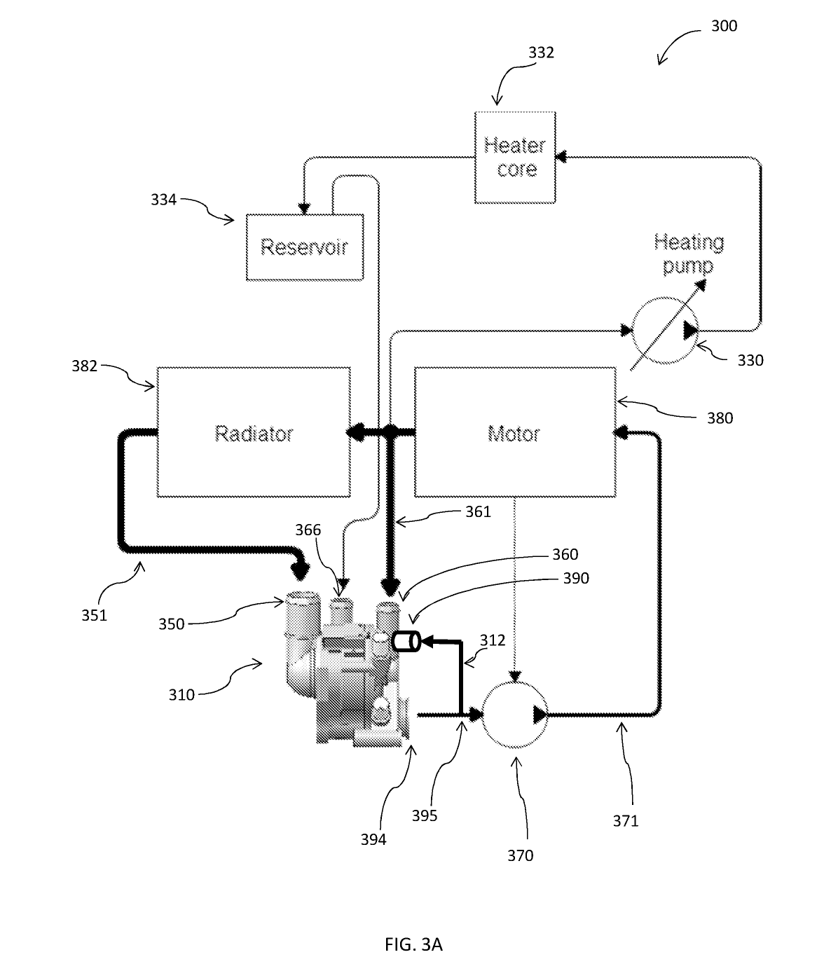

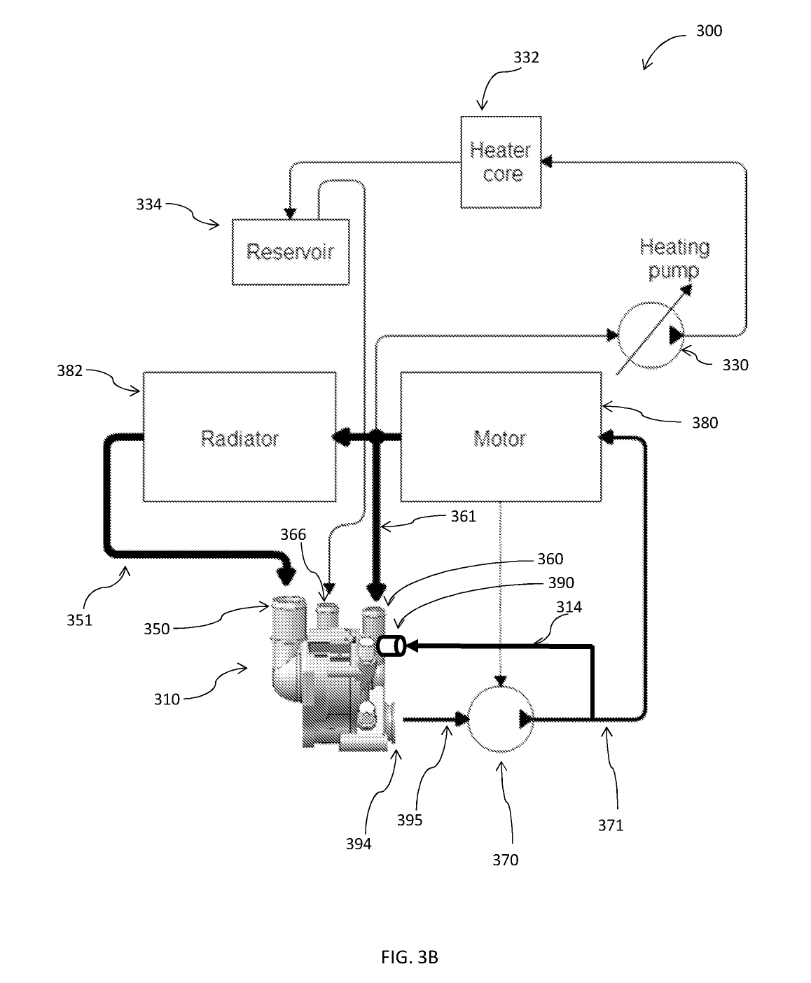

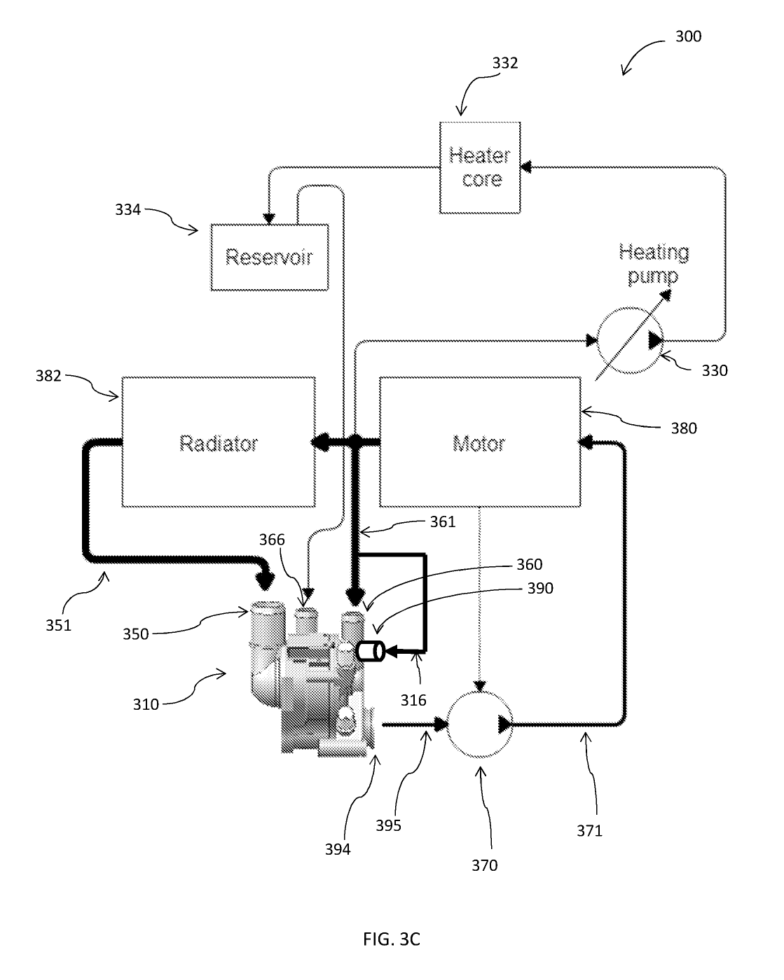

Reference is now made to FIGS. 3A-C, which illustrate a flow diagram 300 of a thermostat 310 with other components, according to some embodiments. In these exemplary diagrams, an output orifice 394 of thermostat 310 is connected to a pump 370 via output pipe 395. The pump 370 delivers fluids to a motor 380 via pipe 371. After fluid passes through motor 380, it passes both to a radiator 382 (through radiator pipe 351 and through radiator orifice 350) and to thermostat 310 through motor pipe 361 and through motor orifice 360. Optionally, fluid may also go from motor 380 to a heating pump 330 then to a heater core 332, then to a reservoir 334 and then back to thermostat 310 through heater orifice 366.

Thus, according to some embodiments, radiator 382 is configured to receive high temperature fluid from motor 380, cool it down and provide low temperature fluids to thermostat 310 via radiator pipe 351 through radiator orifice 350.

According to some embodiments, heating pump (optional) 330, heater core (optional) 332 and reservoir (optional) 334 are configured to provide high temperature fluid to thermostat 310 when motor is not warm.

In FIG. 3A, thermostat 310 receives sample fluids to sample orifice 390 through a conduit 312 which is configured to receive sample fluids from output orifice 394 (for example from output pipe 395) of thermostat 310. Advantageously, sample fluids from output orifice 394 of thermostat 310 are relatively well-mixed, and may provide an accurate indication for the temperature of fluids sent to motor 380.

In FIG. 3B, thermostat 310 receives sample fluids to sample orifice 390 through a conduit 314 which is configured to receive sample fluids from an output of pump 370 (for example from pump pipe 371). Advantageously, sample fluids from an output of pump 370 are homogeneously mixed, and may provide accurate indication for the temperature of fluids sent to motor 380.

In FIG. 3C, thermostat 310 receives sample fluids to sample orifice 390 through a conduit 316 which is configured to receive sample fluids from an output of motor 380 (for example from motor pipe 361). Advantageously, sample fluids from an output of motor 380 are homogeneously mixed, and may provide accurate indication of the temperature of motor 380 without being affected by fluids delivered from radiator 382 or optional reservoir 334.

According to some embodiments, the sample orifice is configured to provide a sample fluid flow of approximately 5 cc/sec. According to some embodiments, the sample orifice is configured to provide a sample fluid flow ranging from 0.2 cc/sec to 10 cc/sec.

According to some embodiments, the sample orifice has a cross-section surface of approximately 2 mm². According to some embodiments, the sample orifice has a cross-section surface ranging between 1 mm² and 40 mm².

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

What we claim is:

1. A thermostat for controlling flow of a coolant fluid through an aperture, the thermostat comprising:
a temperature sensitive valve for controlling an opening and closing of said aperture, said temperature sensitive valve comprising:
a valve body comprising a heat sensitive material and a displaceable pin, wherein said displaceable pin is at least partially inserted within said heat sensitive material; and,
a coolant input orifice configured to convey coolant fluid from a radiator to said valve;
a main input orifice configured to convey fluid from an engine to said valve;
an output orifice configured to release fluid from said valve; and
a sample orifice configured to deliver a sample fluid to said valve body such that a temperature of said heat sensitive material is affected by temperature changes in the sample fluid.

2. The thermostat of claim 1, further comprising a sleeve at least partially surrounding said valve body, said sleeve is configured to receive the sample fluid and introduce it to said valve.

3. The thermostat of claim 2, wherein said sleeve is a tubular structure.

4. The thermostat of claim 1, wherein said sample orifice has a cross-section surface of at least 1 mm².

5. The thermostat of claim 1, wherein said sample orifice is configured to deliver sample fluid from a pump to said valve body.

6. The thermostat of claim 1, wherein said sample orifice is configured to deliver sample fluid from an engine to said valve body.

7. The thermostat of claim 1, wherein said sample orifice is configured to deliver sample fluid from said output orifice to said valve body.

8. The thermostat of claim 1, wherein said temperature sensitive valve further comprises an upper lid, connected to or integrally formed with a flange and configured to reversibly seal said aperture.

9. A method for controlling flow of a coolant fluid through an aperture, the method comprising:
providing a temperature sensitive valve comprising a heat sensitive material and a displaceable pin and an upper lid, integrally formed with a flange and configured to reversibly seal the aperture by the displacement of the pin;
introducing sample fluids to the temperature sensitive valve through a sample orifice; and
controlling an opening and closing of the aperture based on temperatures of the sample fluids introduced to the heat sensitive valve.

10. The method of claim 9, wherein the temperature sensitive valve further comprises a sleeve configured to receive the sample fluids from the sample orifice and introduce them to the valve.

11. The method of claim 10, wherein the sleeve is a tubular structure.

12. The method of claim 9, wherein the sample orifice is configured to deliver sample fluid from a pump to said valve body.

13. The method of claim 9, wherein the sample orifice is configured to deliver sample fluid from an engine to said valve body.

14. The method of claim 9, wherein the temperature sensitive valve further comprises an output orifice and the sample orifice is configured to deliver sample fluid from the output orifice to said valve body.
